(19) United States
(12) Patent Application Publication
(10) Pub. No.: US 2018/0077626 A1
(43) Pub. Date: Mar. 15, 2018

(54) SYSTEMS AND METHODS FOR CONTROLLING ACCESS TO MOBILE DEVICES

(71) Applicant: Inc-You, LLC, Monte Sereno, CA (US)

(72) Inventors: Thomas W. WILSON, JR., Saratoga, CA (US); Eric MONSEF, Monte Sereno, CA (US)

(21) Appl. No.: 15/261,400

(22) Filed: Sep. 9, 2016

(51) Int. Cl. H04W 48/04; H04W 4/04

(52) U.S. Cl. CPC H04W 48/04; H04W 4/046

(57) ABSTRACT

Systems and methods are provided for controlling a user's access to a mobile device in a vehicle. For example, a method includes receiving, at a controlling device, vehicle data related to an operation status of a vehicle. The method includes determine whether the vehicle is in a motion state by comparing the vehicle data to a threshold. When the vehicle data exceeds the threshold, the method includes determining that the vehicle is in the motion state and sending, to a mobile device, a blocking signal in order to prevent a user from using the mobile device for at least one function. When the vehicle data does not exceed the threshold, the method includes determining that the vehicle is not in the motion state and sending, to the mobile device, an accessing signal in order to allow the user to use the mobile device for the at least one function.

### BACKGROUND

### Technical Field

The present disclosure relates generally to controlling access to mobile devices based on external events.

### Description of the Related Art

It is desirable on many occasions to control access to a user's mobile device.

For example, when the user is driving, it is dangerous or unlawful for the user to use his or her mobile device. Some statistics show that when a driver is talking and/or listening while driving, the likelihood of accidents will be increased by 1.3 times; when a driver is dialing, the likelihood of accidents will be increased by 2.8 times; when a driver is reaching for device, the likelihood of accidents will be increased by 1.4 times; and when a driver is texting while driving, the likelihood of accidents will be increased by 23 times. It will be desirable to detect that the user is driving and restrict the user from accessing his or her mobile device.

As another example, when a user is in a meeting or in a restaurant, he or she may not want to be disturbed by phone calls, text messages, or other notifications. It will be desirable to detect that the user is in a meeting or in a restaurant and restrict the user from accessing to his or her mobile device.

Accordingly, it is desirable to provide methods and systems of controlling access to mobile devices based on external events.

### SUMMARY

In accordance with the present disclosure, systems, methods, and computer readable media are provided for controlling access to mobile devices.

Disclosed subject matter includes, in one aspect, a method for controlling a user's access to a mobile device in a vehicle. The method includes receiving, at a controlling device from an information unit, vehicle data related to an operation status of a vehicle; determining, at the controlling device, whether the vehicle is in a motion state by comparing the vehicle data to a threshold; when the vehicle data exceeds the threshold: determining, at the controlling device, that the vehicle is in the motion state, and sending, at the controlling device to a mobile device in the vehicle, a blocking signal in order to prevent a user from using the mobile device for at least one function; and when the vehicle data does not exceed the threshold: determining, at the controlling device, that the vehicle is not in the motion state, and sending, at the controlling device to the mobile device, an accessing signal in order to allow the user to use the mobile device for the at least one function.

Disclosed subject matter includes, in another aspect, a device configured to control a user's access to a mobile device in a vehicle. The device includes a transceiver, a memory, and a processor. The transceiver can be configured to (1) receive vehicle data related to an operation status of a vehicle and (2) transmit a blocking signal or an accessing signal to a mobile device. The memory stores a module. The processor is configured to run the module stored in the memory that is configured to cause the processor to do the following steps. The processor determines whether the vehicle is in a motion state by comparing the vehicle data to a threshold. When the vehicle data exceeds the threshold, the processor determines that the vehicle is in the motion state and generates the blocking signal in order to prevent a user from using the mobile device for at least one function. When the vehicle data does not exceed the threshold, the processor determines that the vehicle is not in the motion state and generates the accessing signal in order to allow the user to use the mobile device for the at least one function.

Disclosed subject matter includes, in yet another aspect, a non-transitory computer readable medium for controlling a user's access to a mobile device in a vehicle. The non-transitory computer readable medium includes executable instructions operable to cause an apparatus to receive, from an information unit, vehicle data related to an operation status of a vehicle. The instructions are further operable to cause the apparatus to determine whether the vehicle is in a motion state by comparing the vehicle data to a threshold. When the vehicle data exceeds the threshold, the instructions are further operable to cause the apparatus to determine that the vehicle is in the motion state and send, to a mobile device in the vehicle, a blocking signal in order to prevent a user from using the mobile device for at least one function. When the vehicle data does not exceed the threshold, the instructions are further operable to cause the apparatus to determine that the vehicle is not in the motion state and send, to the mobile device, an accessing signal in order to allow the user to use the mobile device for the at least one function.

There has thus been outlined, rather broadly, the features of the present disclosure in order that the detailed description thereof that follows may be better understood, and in order that the present contribution to the art may be better appreciated. There are, of course, additional features of the present disclosure that will be described hereinafter and which will form the subject matter of the claims appended hereto.

In this respect, before explaining at least one embodiment of the present disclosure in detail, it is to be understood that the present disclosure is not limited in its application to the details of construction and to the arrangements of the components set forth in the following description or illustrated in the drawings. The present disclosure is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

These together with the other objects of the present disclosure, along with the various features of novelty which characterize the present disclosure, are pointed out with particularity in the claims annexed to and forming a part of this disclosure. For a better understanding of the present disclosure, its operating advantages and the specific objects attained by its uses, reference should be made to the accompanying drawings and descriptive matter in which there are illustrated embodiments of the present disclosure.

### BRIEF DESCRIPTION OF THE DRAWINGS

Various objects, features, and advantages of the present disclosure can be more fully appreciated with reference to the following detailed description of the present disclosure when considered in connection with the following drawings, in which like reference numerals identify like elements.

FIG. 1 illustrates a diagram of a system for controlling access to mobile devices according to some embodiments of the present disclosure.

FIG. 2 illustrates a block diagram of a controlling device according to some embodiments of the present disclosure.

FIG. 3 illustrates a block diagram of a controller in a controlling device according to some embodiments of the present disclosure.

FIG. 4 illustrates a block diagram of a controlling device according to some embodiments of the present disclosure.

FIG. 5 illustrates a method of controlling access to mobile devices according to some embodiments of the present disclosure.

### DESCRIPTION

In the following description, numerous specific details are set forth regarding the systems, methods and media of the present disclosure and the environment in which such systems, methods and media may operate, etc., in order to provide a thorough understanding of the present disclosure. It will be apparent to one skilled in the art, however, that the present disclosure may be practiced without such specific details, and that certain features, which are well known in the art, are not described in detail in order to avoid complication of the present disclosure. In addition, it will be understood that the examples provided below are exemplary, and that it is contemplated that there are other systems, methods, and media that are within the scope of the present disclosure.

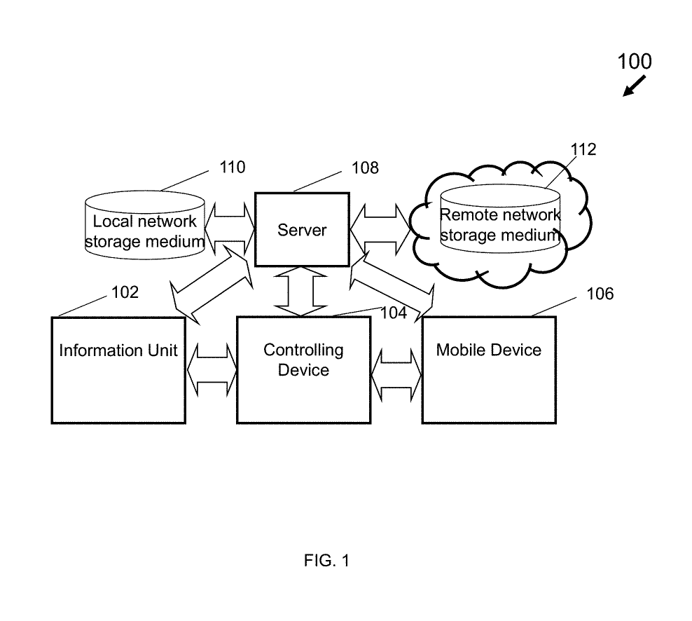

FIG. 1 illustrates a diagram of a system 100 for controlling access to mobile devices according to some embodiments of the present disclosure. The system 100 can include an information unit 102, a controlling device 104, a mobile device 106, and a server 108. Some or all components of the system 100 can be coupled directly or indirectly to a communication network (not shown). The components included in the system 100 can be further broken down into more than one component and/or combined together in any suitable arrangement. Further, one or more components can be rearranged, changed, added, and/or removed. For example, FIG. 1 shows a local network storage medium 110 and a remote network storage medium 112 can be coupled to the server 108. In some embodiments, other components of the system 100 can also have one or more storage media. For example, in some embodiments, the mobile device 106 can be coupled to the remote network storage medium and/or other cloud storage.

The information unit 102 is configured to provide information to the controlling device 104. In some embodiments, the information unit 102 can provide information to the controlling device 104 via an encrypted wireless or encrypted wired link. As a non-limiting example, the information unit 102 can provide one or more categories of data related to a vehicle. The data can include the velocity of the vehicle. The velocity can be expressed in miles per hour (mph), kilometers per hour (kph), or any other suitable unit. The data can also include power, engine throttle position, frequency of rotation of the engine, state of transmission, and/or vehicle identification number (VIN) of the vehicle. For example, the frequency of rotation can be expressed in revolutions per minute (rpm). In some embodiments, the state of transmission can be park, neutral, reverse, drive, and/or any other suitable state. The data can include any other suitable information or combination of information.

When the information unit 102 is used to provide data of the vehicle, it can be located on-board with the vehicle. For example, the information unit 102 can be or connected to an on-board diagnostics (“OBD”) system that is commonly built into cars, trucks, and other vehicles. In some embodiments, the information unit 102 can be or connected to a controller area network (CAN) bus that is commonly built into cars, truck, and other vehicles. In some embodiments, the information unit 102 can be located at a different location from the vehicle. For example, the information unit 102 can be a remote server that receives data from the vehicle via an OBD system or any other suitable component. In some embodiments, the information unit 102 can access data directly from one or more sensors on the vehicle or any location on the vehicle data bus.

The controlling device 104 is configured to control the mobile device 106 based on state information received from the information unit 102. In some embodiments, if the information unit 102 provides the controlling device 104 with data related to the vehicle, the controlling device 104 can determine whether or not the vehicle is in a motion state and control a user's access to the mobile device 106 accordingly. For example, when the controlling device 104 receives the velocity of the vehicle from the information unit 102, it can compare the velocity to a threshold. When the vehicle's velocity exceeds the threshold, the controlling device 104 determines that the vehicle is in a motion state; when the vehicle's velocity does not exceed the threshold, the controlling device 104 determines that the vehicle is not in a motion state. In some embodiments, the threshold can be a zero velocity, so that if the vehicle's velocity is greater than zero, the controlling device 104 determines that the vehicle is in a motion state; if the vehicle's velocity is zero or substantially zero, the controlling device 104 determines that the vehicle is not in a motion state. In some embodiments, the threshold can be slightly higher than 0, such as, for example, 0.5 mph, 1 mph, 3 mph, 5 mph, or any other suitable value. In some embodiments, the controlling device 104 will compare the velocity of the vehicle to the threshold for every refreshing period. For example, the controlling device 104 can compare the velocity of the vehicle to the threshold every 10 seconds, so that the state of the vehicle determined by the controlling device 104 will not be changed within the 10 seconds period. In some embodiments, other suitable refreshing period can be used. In some embodiments, the value can also be derived from an algorithm or combination of variables, such as the velocity and the transmission state of the vehicle. For example, in some embodiments, the controlling device 104 will send a blocking signal when the velocity of the vehicle is greater than zero and/or the state of transmission is in drive state. In some embodiments, the controlling device 104 will send an accessing signal when the velocity of the vehicle is substantially at zero and/or the state of transmission in in park state. In some embodiments, the information unit 102 can also be configured to determine whether or not the vehicle is in a motion state based on data collected by the information unit 102 and pass the determination to the controlling device 104.

When the controlling device 104 determines that the vehicle is in a motion state, or receives a communication from the information unit 102 that the vehicle is in a motion state, the controlling device 104 can send a blocking signal to the mobile device 106 in order to prevent the user from accessing certain functions of the mobile device 106.

For example, in some embodiments, when the vehicle is in a motion state, the controlling device 104 can send the blocking signal to the mobile device 106 so that the user cannot use the mobile device to make/receive voice calls, send/receive text messages, send/receive electronic mail, browse a web browser, play a game, access certain applications, and/or any other suitable function or combination of functions. In some embodiments, the blocking signal can put the mobile device 106 in a locked or restricted state so that the user cannot access any function of the mobile device, except for, in some cases, the capability of making an emergency call. In some embodiments, during the locked state, the user may still be allowed to use GPS maps. In some embodiments, during the locked state, the mobile device 106 may still be allowed to provide one or more functions using WiFi, Bluetooth, and/or other suitable communication standard. For example, in some embodiments, during the locked state, the mobile device 106 may be allowed to play audio and/or serve as a hotspot. In some embodiments, the mobile device 106 may be running an application that is frequently polling the controlling device 104 for the state of the vehicle, and if the result of the polling shows the vehicle is in a motion state, the mobile device 106 can be entered into a locked state as described above.

When the controlling device 104 determines that the vehicle is not in a motion state, it can send an accessing signal to the mobile device 106. If the mobile device 106 was previously under a restricted or locked mode, the accessing signal can allow the user to use the mobile device 106 for functions that were previously locked. As described above, in some embodiments, the mobile device 106 may be running an application that is frequently polling the controlling device 104 for the state of the vehicle, and if the result of the polling shows the vehicle is not in a motion state, the mobile device 106 can be allowed to provide one or more functions that are otherwise restricted in a locked state.

In some embodiments, the controlling device 104 can also receive certain information from the mobile device 106. For example, the controlling device 104 can receive data such as an international mobile station equipment identity (IMEI), a serial number, and/or a device state of the mobile device 106. In some embodiments, the device state can indicate whether or not the mobile device is in a locked state.

In some embodiments, the controlling device 104 can send the data received from the information unit 102 and/or the data received from the mobile device 106 to a server 108. In some embodiments, a user can control when the controlling device 104 sends data to the server 108. In some embodiments, the controlling device 104 can automatically send data to the server 108 under certain triggering events. For example, the triggering event can be an accident in which the vehicle is involved. The controlling device 104 can determine that the vehicle has been in an accident if, for example, the data from the information unit 102 indicates the vehicle experienced an abrupt deceleration or a significant impact. In some embodiments, the data related to the vehicle and/or the mobile device 106 can reside on the information unit 102. In some embodiments, the data can be in encrypted form. In some embodiments, accessing to the data residing on the information unit 102 and/or other locations can be controlled by the controlling device 104 so that such access can be secured.

In some embodiments, the controlling device 104 may be able to send a blocking signal independent of the information unit 102. This signal may consist of a unique ID that is determined by the mobile device 106. This unique ID may or may not be encrypted. Also, this blocking signal can be determined by various states derived in the controlling device 104.

In some embodiments, the controlling device 104 may be able to send a blocking signal based on information received from the remote network 112.

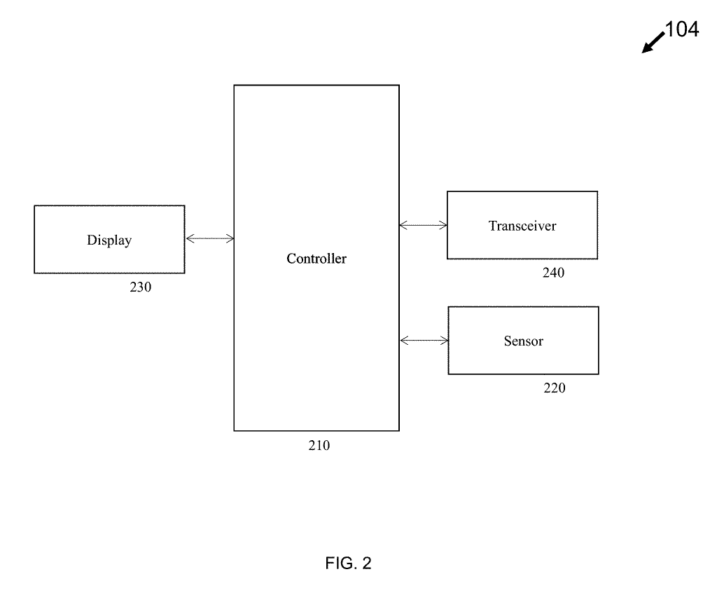

The structure of the controlling device is explained in more detail below in connection with FIGS. 2-4.

The mobile device 106 can be a smartphone. In some embodiments, the mobile device 106 can be a wearable device such as a smart watch, a fitness band, or any other suitable device. In some embodiments, the mobile device 106 can also include a laptop computer, a tablet computer, or any other suitable device.

The server 108 can be configured to receive data from the information unit 102, the controlling device 104, the mobile device 106, and/or other suitable components of the system 100. In some embodiments, the server 108 can be configured to transmit data to the information unit 102, the controlling device 104, the mobile device 106, and/or other suitable components of the system 100. In some embodiments, the server 108 can transmit data to other servers. In some embodiments, when the controlling device 104 transmits data to the server 108 during an accident, the server 108 can provide the relevant information to an insurance agency and/or other relevant parties. For example, controlling device 104 can transmit the device state of the mobile device 106 to the server 108. If the mobile device 106 is in a locked state, then it can be used as an evidence to show the driver was not talking, texting, or otherwise using the mobile device before the accident. Similarly, if the user is pulled over and cited for texting while driving, then the device state of the mobile device 106 can be it can be used as an evidence to show the driver was not talking, texting, or otherwise using the mobile device before the accident.

The server 108 can operate using operating system (OS) software. In some embodiments, the OS software is based on a Linux software kernel and runs specific applications in the server 108, such as monitoring tasks and providing protocol stacks. The OS software allows resources to be allocated separately for control and data paths. For example, certain packet accelerator cards and packet services cards are dedicated to performing routing or security control functions, while other packet accelerator cards/packet services cards are dedicated to processing network traffic. As network requirements change, hardware resources can be dynamically deployed to meet the requirements in some embodiments

The local network storage medium 110 and the remote network storage medium 112 can each include at least one physical, non-transitory storage medium, flash memory, a magnetic disk drive, an optical drive, a programmable read-only memory (PROM), a read-only memory (ROM), or any other memory or combination of memories. The local network storage medium 110 and the remote network storage medium 112 can be part of the server 108 and/or the controlling device 104 or can be separated from the server 108 and/or the controlling device 104.

In some embodiments, the components in the system 100 can communicate with one another through one or more communication networks. The communication network can accommodate public, private, and/or encrypted data communication. For example, the communication network can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. In some embodiments, the communication network can be any suitable wireless connection including, without limitation, Bluetooth (including Bluetooth Low Energy (BLE)), NFC, WiFi, cellular, and/or other communication standards.

FIG. 2 illustrates a block diagram of the controlling device 104 according to some embodiments of the present disclosure. The controlling device 104 can include a controller 210, a sensor 220, a display 230, and a transceiver 240. The components included in the controlling device 104 can be further broken down into more than one component and/or combined together in any suitable arrangement. Further, one or more components can be rearranged, changed, added, and/or removed.

The controller 210 can receive data from other components of the system 100 via the transceiver 240. The controller 210 can also transmit data to other components of the system 100 via the transceiver 240.

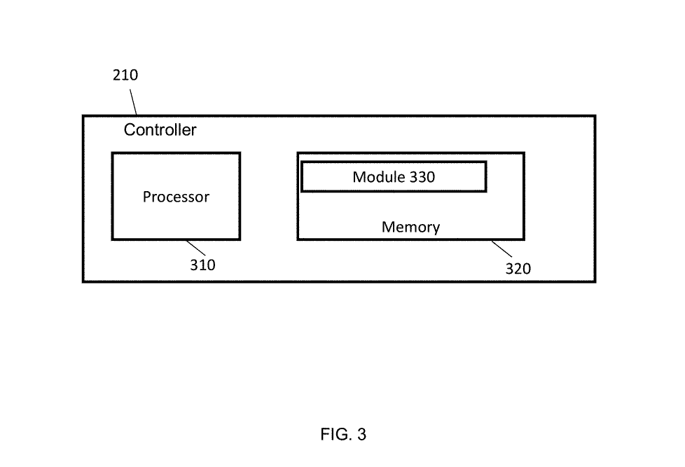

FIG. 3 illustrates a block diagram of the controller 210 according to some embodiments of the disclosed subject matter. The controller 210 includes a processor 310 and a memory 320. The memory 320 includes a module 330. The module 330 can be configured to cause the processor 310 to perform various steps that are discussed in the present disclosure. The controller 210 may include additional modules, fewer modules, or any other suitable combination of modules that perform any suitable operation or combination of operations.

In some embodiments, the processor 310 can include one or more cores and can accommodate one or more threads to run various programs, applications and/or modules. The software can run on the processor 310 capable of executing computer instructions or computer code. The processor 310 might also be implemented in hardware using an application specific integrated circuit (ASIC), programmable logic array (PLA), field programmable gate array (FPGA), or any other integrated circuit.

The memory 320 can be a non-transitory computer readable medium, flash memory, a magnetic disk drive, optical drive, a PROM, a ROM, or any other memory or combination of memories.

The processor 310 can be configured to run the module 330 stored in the memory 320 that is configured to cause the processor 310 to perform various steps that are discussed in the present disclosure.

Referring back to FIG. 2, the sensor 220 can include one or more motion sensors. For example, the sensor 220 can include an accelerometer. In some embodiments, the accelerometer can measure linear acceleration in up to three-dimensions. In some embodiments, the accelerometer can sense an abrupt deceleration experienced by the vehicle, and this information may be used to infer that the vehicle has an accident.

In some embodiments, the sensor 220 may also include other types of sensor. For example, the sensor 220 can be a sensor that senses when the vehicle is impacted, and this information may be used to infer that the vehicle has an accident.

The display 230 can be configured to display operation information of one or more components of the system 100. For example, the display 230 can display data related to the vehicle, such as velocity, power, engine throttle position, frequency of rotation, VIN, state of transmission, and/or any other suitable data of the vehicle. They display 230 can also display data related to the mobile device 106. For example, the display 230 can display an IMEI, a serial number, and/or a device state of the mobile device 106. The display 230 may be a screen. In some embodiments, the display 230 can be a touchscreen, so that it can also be configured to receive input from the user via touch.

In some embodiments, the display 230 can be one or more LEDs or nay other suitable light source. The display 230 can then use different color to indicate different states of the vehicle and/or the mobile device 106. For example, if the mobile device 106 is in a locked state, the display 230 can be in one color; and if the mobile device 106 is not in a locked state, the display 230 can be in another color.

The transceiver 240 can receive data from the information unit 102, the mobile device 106, the server 108, and/or any other suitable component of the system 100. The transceiver 240 can transmit data to the information unit 102, the mobile device 106, the server 108, and/or any other suitable component of the system 100. The transceiver 240 can also transmit and receive data within the controlling device 104. The transceiver 240 can transmit and/or receive data through a wired connection and/or through a wireless connection. The transceiver 240 can be implemented in hardware using an ASIC, PLA, FPGA, or any other integrated circuit.

In some embodiments, the controlling device 104 can include more than one transceiver 240. For example, the controlling device 104 can have one transceiver that is dedicated to communicating with the mobile device 106. The controlling device 104 can also have other transceivers that are dedicated to communicating with other components of the system 100.

In some embodiments, the transceiver 240 can have separate receiver and transmitter. In some embodiments, the receiver rand transmitter can locate at different locations of the controlling device 104.

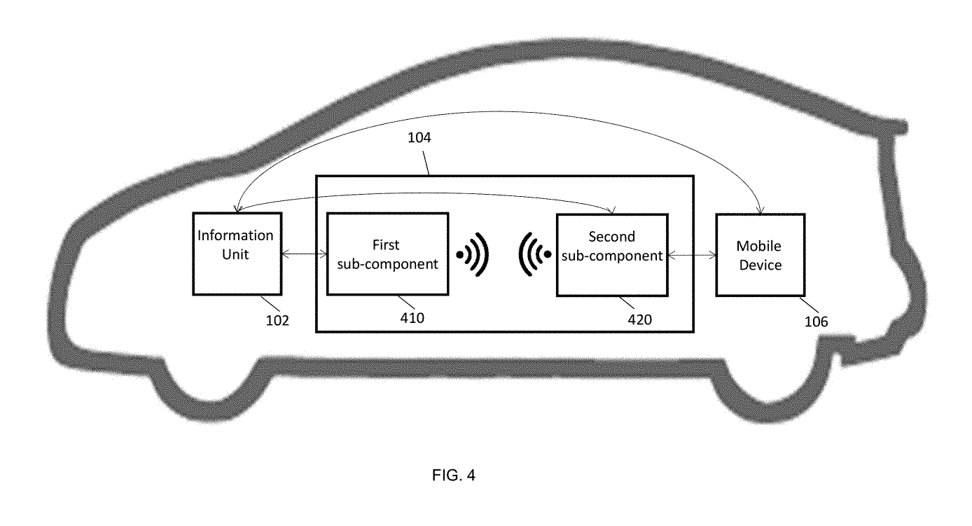

In some embodiments, the controlling device 104 can have more than one sub-component, and each sub-component can locate at a different location. For example, FIG. 4 illustrates a block diagram of the controlling device 104 according to some embodiments of the present disclosure. In FIG. 4, the controlling device 104 has two sub-components, a first sub-component 410 and a second sub-component 420. Each of the sub-components 410 and 420 can have one or more of following components: the controller 210, the sensor 220, the display 230, the transceiver 240, and/or any other suitable component.

In some embodiments, the first sub-component 410 can communicate with the information unit 102 through wireless connection or wired connection. For example, in some embodiments, the first sub-component 410 can be plugged into an OBD port of the vehicle to read data such as velocity, power, engine throttle position, frequency of rotation, VIN, state of transmission, and/or any other suitable data of the vehicle. In some embodiments, the connection can be encrypted.

In some embodiments, the first sub-component 410 include one controller 210, which can determine whether or not the vehicle is in a motion state by comparing the data from the information unit 102 to one or more thresholds. The first sub-component 410 can also include the display 230, which can display the state of the vehicle. When the first sub-component 410 and the second sub-component 420 are at different locations, each of the sub-components 410 and 420 can have a transceiver 240 to communicate with each other. For example, the first sub-component 410 can broadcast the state of the vehicle to the second sub-component 420 every 200 ms, or any other suitable duration. In some embodiments, the first sub-component 410 and the second sub-component 420 can communicate with each other through wired connection, such as a cable.

In some embodiments, the second sub-component 420 can communicate with the mobile device 106 through wireless connection or wired connection. In some embodiments, the connection can be encrypted. In some embodiments, the second sub-component 420 can be in a cable form, with one end connected to a port of the vehicle, such as a universal serial bus (USB) port, and the other end connected to the mobile device 106 through a micro USB port, or any other suitable port. As described above, the second sub-component 420 can include a transceiver 240 so that it can receive wireless status, such as the state of the vehicle, from the first sub-component 410. In some embodiments, when the sub-component 420 is plugged into the mobile device 106, it can cause the mobile device 106 to launch an application. In some embodiments, the second sub-component 420 can generate a blocking signal if the first sub-component 410 determines the vehicle is in a motion state. Similarly, the second sub-component 420 can also generate an accessing signal if the first sub-component 410 determines the vehicle is not in a motion state. In some embodiments, the blocking signal and the accessing signal can be a state signal received from the first sub-component 410. In some embodiments, the blocking signal and the accessing signal can be generated by the first sub-component 410. In some embodiments, the blocking signal can put, via the application in the mobile device 106, the mobile device 106 into a locked state so that the user cannot use the mobile device to make/receive voice calls, send/receive text messages, and/or any other suitable function. In some embodiments, the blocking signal can put the mobile device 106 in a locked state so that the user can use the mobile device 106 for one or more functions that were previously locked.

Although, in some embodiments, the second sub-component 420 can be in a cable form, it can be different from a regular cable connecting the mobile device 106 to a vehicle in one or more aspects. For example, in some embodiments, when a regular cable connects the mobile device 106 to a USB port in a vehicle, the mobile device 106 will be switched into a special mode such as a CarPlay™ or an auto mode. The second sub-component 420 can dynamically disable this mode switching. In some embodiments, the second sub-component 420 can always prevent USB connection between the mobile device 106 and the vehicle for any data purpose. In some embodiments, the second sub-component 420 can include one or more memory modules to store any data readout from the mobile device 106. In some embodiments, the second sub-component 420 can include a unique ID so that the second sub-component 420 can be uniquely paired with the mobile device 106 via encryption. In other words, in some embodiments, if the second sub-component 420 is plugged in a mobile device 106 that is not paired with the unique ID of the second sub-component 420, the second sub-component 420 can function as a normal cable device for charging, mode switching (such as switching into the CarPlay™ or auto mode), and/or any other suitable function. In some embodiments, the second sub-component 420 can be uniquely paired with the first sub-component 410 via a wireless and/or wired connection. In some embodiments, the connection can be encrypted. In some embodiments, the second sub-component 420 can be uniquely paired with the information unit 102 via a wireless and/or wired connection. In some embodiments, the connection can be encrypted. In some embodiments, components in FIG. 4, such as the information unit 102, the first sub-component 410, the second sub-component 420, and the mobile device 106, can communicate with the one another via wireless and/or wired connection.

In some embodiments, a user may want a convenient way to enable a particular setting such as a do not disturb setting by using a physical device such as a cable or dongle. In some embodiments, the second sub-component 420 can be a smart USB cable, a dongle, and/or any other suitable form that can be plugged into the mobile device 106. In some embodiments, when the second sub-component 420 is plugged into the mobile device 106, it can send a signal to place the mobile device 106 in a locked or restricted state as described above. In some embodiments, when the second sub-component 420 is plugged into the mobile device 106, it can provide a signal and/or a piece of information to the operating system or an application running in the mobile device 106, and the operating system or the application, upon receiving the signal and/or the piece of information, can be configure to place the mobile device 106 in a locked or restricted state as described above.

In some embodiments, the information unit 102, the first sub-component 410, and/or the second sub-component 420 can send an accessing signal, directly or via other component, to the mobile device 106 under certain conditions, such as, for example, when the velocity of the vehicle is substantially at zero and/or the transmission state of the vehicle is in park state. If the mobile device 106 was previously under a restricted/locked mode, the accessing signal can allow the user to use the mobile device 106 for functions that were previously locked.

In some embodiments, there can be several second sub-components 420, each of them can be connected to one mobile device 106. For example, in a vehicle, there can be five or any other suitable number of second sub-component 420, each of the second sub-components 420 can be connected to a mobile device 106 of each passenger. As another example, at a public performance, there can be 500 or any other suitable number of second sub-components 420, each of the second sub-components 420 can be connected to a mobile device 106 of each attendee.

In some embodiments, the controlling device 104, or its sub-component such as the first sub-component 410 or the second sub-component 420, can be integrated in an ignition key. In some embodiments, the controlling device 104, or its sub-component such as the first sub-component 410 or the second sub-component 420, can be integrated in a case of the mobile device 106.

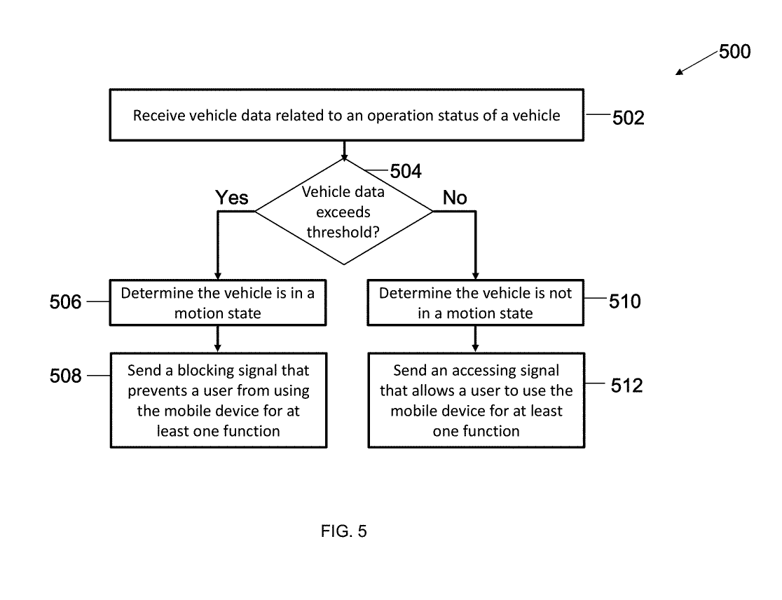

FIG. 5 is a flow chart illustrating a computerized process 500 of controlling access to the mobile device 106 in accordance with some embodiments of the present disclosure. In some embodiments, the computerized process 500 can be modified by, for example, having steps rearranged, changed, added, and/or removed.

At step 502, the controlling device 104 receives, from the information unit 102, data related to an operation status of the vehicle. The data can include the velocity of the vehicle. The velocity can be expressed in mph, kph, or any other suitable unit. The data can also include power, engine throttle position, frequency of rotation of the engine, state of transmission, and/or VIN of the vehicle. For example, the frequency of rotation can be expressed in rpm. The data can include any other suitable information or combination of information. The computerized process 500 then proceeds to step 504.

At step 504, the controlling device 104 determines whether the vehicle is in a motion state by comparing data received from the information unit 102 to one or more thresholds. When the data exceeds the threshold, the computerized process 500 proceeds to step 506. When the data does not exceed the threshold, the computerized process 500 proceeds to step 510. For example, when the controlling device 104 receives the velocity of the vehicle from the information unit 102, it can compare the velocity to a threshold. When the vehicle's velocity exceeds the threshold, the computerized process 500 proceeds to step 506; when the vehicle's velocity does not exceed the threshold, the computerized process 500 proceeds to step 510. In some embodiments, the threshold can be a zero velocity. In some embodiments, the threshold can be slightly higher than 0, such as, for example, 1 mph, 3 mph, 5 mph, or any other suitable value.

At step 506, the controlling device 104 determines that the vehicle is in a motion state since the data from the information unit 102 exceeds the threshold. For example, in some embodiments, the data is the velocity of the vehicle and the threshold is a zero velocity, and controlling device 104 determines that the vehicle is in a motion state if the velocity is greater than zero. In some embodiments, at step 506, the controlling device 104 can also display that the vehicle in a motion state. The computerized process 500 then proceeds to step 508.

At step 508, the controlling device 104 sends a blocking signal to the mobile device 106 in order to prevent the user from using the mobile device 106 for at least one function. For example, in some embodiments, when the vehicle is in a motion state, the controlling device 104 can send the blocking signal, through wired or wireless connection, to the mobile device 106 so that the user cannot use the mobile device to make/receive voice calls, send/receive text messages, send/receive electronic mail, browse a web browser, play a game, access certain applications, or any other suitable function or combination of functions. In some embodiments, the blocking signal can put the mobile device 106 in a locked state so that the user cannot access any function of the mobile device, except for, in some cases, the availability of making an emergency call. When the controlling device 104 determines that the vehicle is not in a motion state, it can send an accessing signal to the mobile device 106. If the mobile device 106 was previously under a restriction mode, the accessing signal can allow the user to use the mobile device 106 for functions that were previously locked.

At step 510, the controlling device 104 determines that the vehicle is not in a motion state since the data from the information unit 102 does not exceed the threshold. For example, in some embodiments, the data is the velocity of the vehicle and the threshold is a zero velocity, and controlling device 104 determines that the vehicle is not in a motion state if the velocity is substantially at zero. In some embodiments, at step 510, the controlling device 104 can also display that the vehicle is not in a motion state. The computerized process 500 then proceeds to step 512.

At step 512, the controlling device 104 can send an accessing signal, through wired or wireless connection, to the mobile device 106. If the mobile device 106 was previously under a locked/restricted state, the accessing signal can allow the user to use the mobile device 106 for functions, such as access to phone calls and/or access to text messages that were previously locked.

As described above, in some embodiments, the computerized process 500 can include additional steps. For example, in some embodiments, the computerized process 500 can have a step so that the controlling device 104 can also receive certain information from the mobile device 106. For example, the controlling device 104 can receive data such as the IMEI, the serial number, and/or the device state of the mobile device 106. In some embodiments, the device state can suggest that whether or not the mobile device is in a locked state.

In some embodiments, the computerized process 500 can have a step so that the controlling device 104 can send the data received from the information unit 102 and/or the data received from the mobile device 106 to the server 108. In some embodiments, a user can control when the controlling device 104 sends data to the server 108. In some embodiments, the controlling device 104 can automatically send data to the server 108 under certain triggering event. For example, the triggering event can be an accident in which the vehicle is involved. The controlling device 104 can determine that the vehicle has been involved in an accident if, for example, the data from the information unit 102 indicates the vehicle experienced an abrupt acceleration or deceleration.

In the present disclosure, the vehicle can include any motor vehicles, such as scooters, motorcycles, cars, trucks, buses, and/or any other suitable vehicle. In some embodiments, the vehicle can also include bicycles, railed vehicles, watercraft, aircraft, and or any other suitable vehicles.

The present disclosure is not limited to controlling a mobile device in a vehicle. The controlling device 104 can also be triggered to control access to the mobile device 106 under other circumstances. For example, in some embodiments, the controlling device 104 can receive data such as the user's velocity from the information unit 102, and when the user's velocity exceeds a threshold, such as 5 mph or any other suitable value, the controlling device 104 can determine that the user is exercising and place the mobile device 106 into a locked/restricted state. As another example, the controlling device 104 can receive data such as time from the information unit 102, and when the time is about dinner time, the controlling device 104 can place the mobile device 106 into a locked/restricted state. As another example, the controlling device 104 can receive data such as location information from the information unit 102, and when the location information suggests that the user is in a location that the use of a mobile device is restricted, the controlling device 104 can place the mobile device 106 into a locked/restricted state. As yet another example, the controlling device 104 can receive data such as calendar events of a user from the information unit 102, and when the calendar event suggests that the use of a mobile device is restricted, the controlling device 104 can place the mobile device 106 into a locked/restricted state.

It is to be understood that the present disclosure is not limited in its application to the details of construction and to the arrangements of the components set forth in the following description or illustrated in the drawings. The present disclosure is capable of other embodiments and of being practiced and carried out in various ways. In addition, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the present disclosure. It is important, therefore, that the claims be regarded as including such equivalent constructions insofar as they do not depart from the spirit and scope of the present disclosure.

Although the present disclosure has been described and illustrated in the foregoing exemplary embodiments, it is understood that the present disclosure has been made only by way of example, and that numerous changes in the details of implementation of the present disclosure may be made without departing from the spirit and scope of the present disclosure, which is limited only by the claims which follow.

1. A method of controlling a user's access to a mobile device in a vehicle, comprising:
receiving, at the controlling device from an information unit, vehicle data related to an operation status of a vehicle;
connecting a controlling device to a mobile device via a wired connection, wherein the wired connection initially prevents a user from using the mobile device for at least one function independent of the operation status of the vehicle;
determining, at the controlling device, whether the vehicle is in a motion state by comparing the vehicle data to a threshold;
when the vehicle data exceeds the threshold:
determining, at the controlling device, that the vehicle is in the motion state, and preventing the user from using the mobile device for the at least one function; and
when the vehicle data does not exceed the threshold:
determining, at the controlling device, that the vehicle is not in the motion state, and
sending, at the controlling device to the mobile device through the wired connection, an accessing signal in order to allow the user to use the mobile device for the at least one function.

2. The method of claim 1, wherein the at least one function includes at least one of the following: access to phone calls, access to text messages, access to electronic mail, browse a web browser, play a game, or access to certain applications.

3. The method of claim 1, wherein the vehicle data is a velocity of the vehicle and the threshold is substantially zero velocity.

4. The method of claim 1, further comprising:
receiving, at the controlling device from the mobile device, device data of the mobile device; and
sending, at the controlling device to a server, in whole or in part, at least one of the vehicle data or the device data.

5. The method of claim 4, wherein sending, in whole or in part, at least one of the vehicle data or the device data is triggered by an event.

6. The method of claim 4, wherein the device data includes at least one of international mobile station equipment identity (IMEI), serial number, or device state of the mobile device.

7. The method of claim 1, further comprising receiving additional vehicle data, wherein the additional vehicle data includes at least one of engine throttle position, frequency of rotation of an engine, state of transmission, or vehicle identification number of the vehicle.

8. The method of claim 1, further comprising:
receiving, at the controlling device from the mobile device, device data of the mobile device; and
sending, at the controlling device to a server, in whole or in part, at least one of the device data, the vehicle data, or the additional vehicle data.

9. The method of claim 8, wherein sending, in whole or in part, at least one of the device data, the vehicle data, or the device data is triggered by an event.

10. The method of claim 1, further comprising displaying, at the controlling device, whether the vehicle is in the motion state.

11. (canceled)

12. (canceled)

13. A device configured to control a user's access to a mobile device in a vehicle, comprising:
a transceiver configured to (1) receive vehicle data related to an operation status of a vehicle and (2) transmit a blocking signal or an accessing signal to a cable coupled to a mobile device;
a memory that stores a module; and
a processor, coupled to the transceiver, configured to run the module stored in the memory that is configured to cause the processor to:
initially prevent a user from using the mobile device for at least one function independent of the operation status of the vehicle when the mobile device is coupled to the cable;
determine whether the vehicle is in a motion state by comparing the vehicle data to a threshold,
when the vehicle data exceeds the threshold:
determine that the vehicle is in the motion state, and
prevent the user from using the mobile device for the at least one function via the cable, and
when the vehicle data does not exceed the threshold:
determine that the vehicle is not in the motion state, and
generate the accessing signal in order to allow the user to use the mobile device for the at least one function via the cable.

14. The device of claim 13, wherein the at least one function includes at least one of the following: access to phone calls, access to text messages, access to electronic mail, browse a web browser, play a game, or access to certain applications.

15. The device of claim 13, wherein the vehicle data is a velocity of the vehicle and the threshold is substantially zero velocity.

16. The device of claim 13, wherein the transceiver is further configured to:
receive device data from the mobile device directly or through the cable; and
transmit, to a server, in whole or in part, at least one of the vehicle data or the device data.

17. The device of claim 16, wherein the device data includes at least one of international mobile station equipment identity (IMEI), serial number, or device state of the mobile device.

18. The device of claim 13, wherein the transceiver is further configured to receive additional vehicle data, wherein the additional vehicle data includes at least one of engine throttle position, frequency of rotation of an engine, state of transmission, or vehicle identification number of the vehicle.

19. The device of claim 13, further comprising a display unit configured to display whether the vehicle is in the motion state.

20. (canceled)

21. The method of claim 1, wherein the wired connection is encrypted.

22. The method of claim 5, wherein the event is an accident of the car.

23. The device of claim 13, wherein the cable is configured to transmit or receive encrypted data.

24. The device of claim 13, wherein the cable is in a form of a dongle.

25. The device of claim 19, wherein the display unit comprises a light-emitting diode.
